(19) United States
(12) Patent Application Publication
(10) Pub. No.: US 2010/0038602 A1
(43) Pub. Date: Feb. 18, 2010

(54) METHOD FOR PREPARING CARBON FIBRILS AND/OR NANOTUBES FROM A CARBON SOURCE INTEGRATED WITH THE CATALYST

(75) Inventor: Dominique Plee, Lons (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: Arkema France, Colombes (FR)

(21) Appl. No.: 12/519,995

(22) PCT Filed: Dec. 18, 2007
(86) PCT No.: PCT/FR2007/052550

§ 371 Date: Jun. 18, 2009

(30) Foreign Application Priority Data
Dec. 18, 2006 (FR) 0655594
Jan. 5, 2007 (US) 60878806

(51) Int. Cl. H01B 1/12; B01J 31/06; D01F 9/12; C08K 3/04

(52) U.S. Cl. 252/511; 502/159; 423/447.1; 524/496; 977/742; 977/750; 977/752

(57) ABSTRACT

The present invention relates to a method for preparing carbon fibrils and/or nanotubes from a carbon source integrated in the catalyst used for their preparation and a source of hydrocarbonated gas, as well as to the catalyst material and to the corresponding method. The catalyst material for preparing mono- or multi-leaved carbon fibrils and/or nanotubes includes one or more given multivalent transition metals and a hydrocarbonated solid organic substrate.

### FIELD OF THE INVENTION

The present invention relates to a method of preparing carbon nanotubes and/or fibrils from a carbon source integrated with the catalyst used for preparing them, to the catalyst material and to its corresponding method.

### TECHNOLOGICAL BACKGROUND OF THE INVENTION

Carbon fibrils and carbon nanotubes are recognized at the present time as being materials having great advantages because of their mechanical properties, their high aspect (length/diameter) ratios and their electrical properties.

Carbon fibrils generally have a mean diameter ranging from 50 nm to 1 micron, this being greater than that of carbon nanotubes.

Fibrils are composed of relatively organized graphitic regions (or turbostatic stacks), the planes of which are inclined at various angles to the axis of the fiber. They are often hollow along the central axis.

Carbon nanotubes or CNTs terminate in hemispheres consisting of pentagons and hexagons with a structure similar to fullerenes.

Examples of these structures that may be mentioned include inter alia nanotubes composed of a single sheet, which are referred to as single-walled nanotubes (SWNTs) and nanotubes composed of several concentric sheets, which are referred to as multiwalled nanotubes (MWNTs). In general, SWNTs are more difficult to manufacture than MWNTs.

Carbon nanotubes may be produced by various processes, such as electrical discharge, laser ablation or chemical vapor deposition (CVD).

Of these techniques, the latter one seems to be the only one capable of manufacturing carbon nanotubes in large quantities, an essential condition for achieving a cost price that would enable them to be used on a large scale in industrial applications.

In this method, a carbon source is injected at a relatively high temperature onto a catalyst, said catalyst possibly consisting of a metal supported on an inorganic solid. Preferred examples of metals that may be mentioned include: iron, cobalt, nickel and molybdenum, while alumina, silica and magnesia are common supports.

The carbon sources that may be envisaged are methane, ethane, ethylene, acetylene, ethanol, methanol, and acetone, or even CO/H₂ syngas (the HIPCO process).

However, if it is desired to avoid the purification steps after the carbon nanotubes have been recovered, for the purpose of simplifying the method and because certain applications do not require this, it will be particularly beneficial to greatly increase the productivity so as to have the lowest possible ash content.

In addition, with the catalysts of the prior art and in the great majority of cases, the ash consists of a transition metal and alumina, silica or magnesia. The metal itself is often encapsulated and little prone to causing undesirable effects. However, this is not the case with the mineral support which, if it is not removed by a stringent acid treatment, may prove to be damaging in applications such as thin films or fibers, owing to the size of the particles.

It is therefore particularly desirable to avoid the use of an inorganic material, so as to avoid its decomposition during the reaction.

For this purpose, US2006/0115409 discloses a method in which the preparation of the CNTs takes place by in situ decomposition of a mixture comprising polyethylene glycol, as organic material and carbon source, in the presence of a metal catalyst. The mixture, consisting of the metal catalyst dispersed in the polyethylene glycol, is prepared beforehand in a solvent medium before the step of forming the CNTs, which is itself carried out in two steps, by heating to temperatures of 200-400° C. in the first step and then 400-1000° C. in the second step.

However, one of the drawbacks of this method is the large number of steps to be carried out, both for the preparation of the catalyst and for the preparation of the CNTs. Another drawback is the very nature of the catalyst, in dispersion form, or the nature of the organic polymer—polyethylene glycol (PEG)—as component of the catalyst.

This is because, because of the presence of oxygen atoms in its structure, PEG is liable to oxidize any gases used as complementary carbon source, this reaction then competing with carbon nanotube formation, so that it is strongly recommended not to use these gases. The productivity of the method of manufacturing carbon nanotubes is thus greatly limited, thereby making it unsuitable for industrial application.

There therefore exists a need to have other, simpler and more effective methods for manufacturing carbon nanotubes or fibrils. For this purpose, there is also a need to have novel metal catalyst/polymer structures for preparing these carbon fibrils or nanotubes, and also methods for producing such structures.

### SUMMARY OF THE INVENTION

Thus, the invention provides a catalyst material for the preparation of single-walled or multiwalled carbon nanotubes and/or fibrils, comprising:

one or more multivalent transition metals chosen from those of Group VIB, chromium Cr, molybdenum Mo, tungsten W, or those of Group VIIIB, iron Fe, cobalt Co, nickel Ni, ruthenium Ru, rhodium Rh, palladium Pd, osmium Os, iridium Ir and platinum Pt, or mixtures thereof; and

a solid organic substrate chosen from polymers, copolymers and terpolymers that contain only carbon and hydrogen.

Preferably, the organic substrate is a polymer having a BET specific surface of less than 200 m²/g, for example ranging between 0.1 m²/g and 50 m²/g.

The expression <<ranging between>> should be understood not to exclude, within the present invention, the values mentioned as upper and lower bands of the range in question.

Preferably, the organic substrate is chosen from polymers, copolymers and terpolymers, wherein at least some of the repeat units comprise butadiene and/or styrene.

Also, preferably, the organic substrate is chosen from core-shell polymers of the methacrylate/butadiene/styrene type and crosslinked polymers of the polystyrene/divinylbenzene type.

According to the invention, the transition metal may be chosen from iron Fe, cobalt Co and nickel Ni, or one of their mixtures.

The amount of transition metal(s) advantageously represents up to 50% by weight, preferably 1 to 30% and more preferably 1 to 15% by weight, of the final catalyst material.

According to one embodiment, the organic substrate is a porous support which is impregnated with the metal, preferably with the degree of impregnation of the support being up to 40%.

According to one embodiment, the catalyst material according to the invention is in the form of solid particles, the diameter of which ranges between 1 micron and 5 mm.

The invention also relates to a method for preparing the catalyst material described above by bringing the organic substrate into contact with a solution containing at least one of said transition metals in salt form, preferably under a stream of dry gas. This step is generally carried out by a reduction of the metal deposited. To do this, the deposited metal is advantageously reduced in a stream of reducing gas, such as hydrogen.

Preferably, the solution is an aqueous metal nitrate solution, especially an aqueous iron nitrate solution. Preferably, the denitrification of the catalyst takes place in an inert atmosphere.

According to one embodiment, the contacting takes place at a temperature between room temperature and the boiling point of the solution, and the amount of liquid, at any moment, in contact with the substrate is just sufficient to form a film on the surface of the particles.

The invention also relates to a method for preparing single-walled or multiwalled carbon nanotubes and/or fibrils, comprising the steps of:

a) supplying a catalyst material as defined above.

b) growing carbon nanotubes and/or fibrils by thermal decomposition of the organic substrate, by heating the catalyst material to a temperature between 300 and 1200° in the presence of a hydrocarbon gas composition which optionally includes a reducing gas; and

c) cooling and recovery of the carbon nanotubes and/or fibrils formed.

The invention relates more particularly to a method as described above in which the hydrocarbon gas is ethylene used in the presence of hydrogen as reducing gas, the gas composition containing at least 20% hydrogen by volume.

Preferably, step b) is carried out on a fluidized bed in the presence of the hydrocarbon gas and optionally reducing gas, more preferably in the presence of ethylene and hydrogen.

Preferably, the reducing gas is present in step b) of preparing the carbon nanotubes, in such a way that the metal of the catalyst material is reduced in situ during step b).

It will therefore be understood that the method according to the invention makes it possible to manufacture carbon nanotubes and/or fibrils both by decomposition of the organic support and chemical vapor deposition, so that its productivity is at a maximum.

### DETAILED SUMMARY OF EMBODIMENTS OF THE INVENTION

The aim of the invention is to provide a catalyst material for the preparation of single-walled or multiwalled carbon nanotubes and/or fibrils comprising one or more specific multivalent transition metals and an organic hydrocarbon polymer substrate.

### Organic Substrate

The organic substrate is a solid and advantageously porous. It may have a BET specific surface area of less than 200 m²/g, and preferably ranging between 1 m²/g and 50 m²/g.

The substrate is chosen from polymers, copolymers and terpolymers that contain only carbon and hydrogen and that consequently result in a higher yield of ordered fibrils and/or nanotubes.

Preferably, the organic substrate is chosen from polymers, copolymers and terpolymers in which at least some of the repeat units comprise butadiene and/or styrene.

More preferably, it is chosen from core/shell polymers of the methacrylate/butadiene/styrene type or crosslinked polymers of the polystyrene/divinylbenzene type or methacrylate/butadiene/styrene (MBS) copolymers (BET surface area of 1 to 5 m²/g), which are sold in particular by Arkema.

The size of the substrate particles is advantageously chosen so as to allow good fluidization of the catalyst during the carbon nanotube and/or fibril synthesis reaction. In practice, to ensure correct productivity, it is preferable for the substrate particles to have a diameter between 20 and 500 μm.

### Multivalent Transition Metals

The transition metal is a multivalent metal chosen from those of group VIB such as chromium Cr, molybdenum Mo and tungsten W, or those of group VIIIB such as iron Fe, cobalt Co, nickel Ni, ruthenium Ru, rhodium Rh, palladium Pd, osmium Os, iridium Ir and platinum Pt, or mixtures thereof.

Preferably, the metal is chosen from iron Fe, cobalt Co and nickel Ni, or one of their mixtures.

Even more preferably, the metal consists of only iron.

### Catalyst Material

In the catalyst, the organic substrate represents the support on which the metal forms a coating. The metal may be in the form of a film but, as elsewhere, the support is preferably porous and some of the metal may also be in the pores of the catalyst. Thus, it is possible to obtain a catalyst with a degree of metal impregnation ranging up to 40%, preferably from 10 to 35%.

The quantity of transition metal(s) represents up to 50% by weight of the final catalyst. Preferably, and for the purpose of increasing the carbon nanotube and/or fibril productivity, the quantity of metal represents from 1 to 30%, or even from 1 to 15%, of the weight of the final catalyst.

The final catalyst is typically in the form of particles having a diameter ranging from 1 micron to 5 mm, preferably from 10 to 500 μm.

### Method of Preparing the Catalyst Material

The preparation of the catalyst takes place by bringing the organic substrate as described above into contact with a solution containing at least one transition metal, as defined above, in salt form.

The contacting is carried out in principle at a temperature between room temperature and the boiling point of the solution.

The quantity of impregnation solution is determined so that the substrate particles are at all times in contact with a quantity of solution sufficient to ensure the formation of a surface film on said substrate particles.

If the substrate is porous, it is preferably impregnated while the organic substrate is being brought into contact with the solution.

The impregnation of the substrate particles is advantageously carried out in a stream of dry gas, for example by means of an aqueous solution of the metal in salt form, such as for example iron nitrate or cobalt acetate or cobalt nitrate or a mixture of the two metals.

Operating “dry”, that is to say, having at all times just the quantity of liquid needed to create a liquid film on the surface of the catalyst substrate particles, is an advantage as this makes it possible, by heating in a stream of dry air, to avoid aqueous waste (for example aqueous nitrate waste when the impregnation solution contains nitrates). The denitrification of the catalyst then takes place in an inert atmosphere, for example by heating to about 200° C.

Method of Preparing Single-Walled or Multiwalled Carbon Nanotubes and/or Fibrils

In a first step, a catalyst material as described above is supplied.

Next, in a second step, the growth of the carbon nanotubes and/or fibrils takes place by thermal decomposition, preferably on a fluidized bed, of the organic substrate by heating the catalyst material to a temperature between 300 and 1200° C., preferably 500 to 700° C., in the presence of a hydrocarbon gas composition which optionally includes a reducing gas such as hydrogen.

Thus, it is preferred to introduce a hydrocarbon gas by itself or in the presence of hydrogen.

The hydrocarbon gas may especially be chosen from: methane, ethane, ethylene, acetylene, ethanol, methanol, acetone and mixtures thereof, or even CO/H₂ syngas (HIPCO process). It is preferably a hydrocarbon such as methane, ethane, ethylene or acetylene, ethylene being preferred for use in the present invention.

The hydrocarbon gas, such as ethylene, introduced into the reactor, acts as a complementary source of carbon in the preparation of carbon nanotubes and/or fibrils and may, if necessary, be combined with hydrogen or with a mixture of hydrogen and inert gas, such as nitrogen.

The gas composition preferably comprises, by volume, 20 to 100% hydrogen, 0% to 85% and more generally 5% to 80% of hydrocarbon gas, such as ethylene, and optionally an inert gas as complement. It is also preferable for the hydrocarbon gas to be present in a larger quantity (by volume) than the reducing gas. More particularly, the hydrogen/hydrocarbon gas volume ratio advantageously ranges between 1/2 and 1/4, better between 1/2.5 and 1/3.5 and even better still about 1/3.

The hydrogen allows the surface of the catalyst to be cleaned, prevents the formation of randomly organized carbon fibers and promotes the production of ordered carbon nanotubes and/or fibrils. It may also allow the metal deposited on the catalyst to be reduced.

Then, after cooling, the carbon nanotubes and/or fibrils formed are recovered.

In a preferred method of implementation, the catalyst is reduced in situ in the carbon nanotube synthesis reactor, by introducing the catalyst at the reaction temperature. Thus, the catalyst is not exposed to air again, and the metal remains in unoxidized metallic form.

This method has the advantage of achieving a high level of productivity and of obtaining products having a very low ash content, of less than 15% and preferably less than 4%.

### Single-Walled or Multiwalled Carbon Nanotubes and Fibrils

The products obtained have lengths ranging from 1 μm to 7 or 8 μm. The diameters are between 20 and 250 nm, and, in particular in the case of carbon nanotubes, diameters between 10 and 60 nm. The nanotubes are mainly multiwalled.

The fibrils and/or nanotubes obtained according to the method of the invention described above may be used as agents for improving the mechanical and/or thermal and/or electrical conductivity properties in polymeric compositions or may be used to prepare dispersions in solvents.

The fibrils and/or nanotubes obtained may be used in many fields, especially in electronics (depending on the temperature and their structure, they may be conducting, semiconducting or insulating), in engineering, for example for the reinforcement of composites (CNTs are 100 times stronger and 6 times lighter than steel) and in electromechanical applications (they can elongate or contract by charge injection). For example, mention may be made of the use of CNTs in macromolecular compositions intended for example for the packaging of electronic components, for the manufacture of fuel lines, antistatic coatings, in thermistors, electrodes for supercapacitors, etc.

### Examples

The aim of the following examples is to illustrate the invention without limiting the scope thereof.

### Example 1

### Preparation of Metal Catalyst/Polymer Composition No. 1

A catalyst was prepared from methacrylate/butadiene/styrene (MBS) and iron nitrate. The MBS sold by Arkema under the reference C223 had a core-shell structure consisting of an elastomeric butadiene core surrounded by a shell consisting of a methyl methacrylate (36%)/butyl acrylate (4%) layer, then a polystyrene (50%) second layer and a methyl methacrylate (10%) third layer. Depending on the proportions of the various polymers, it was possible to obtain a greater or lesser elastomeric character. The median diameter was around 200 to 250 μm.

Introduced into a jacketed 3-liter reactor heated to 100° C. were 30 g of MBS, a stream of nitrogen being passed therethrough from the bottom up. The MBS particles were therefore in a prefluidization state. Next, 54 g of an iron nitrate nonahydrate solution containing 5.4 g of iron was then continuously injected by means of a pump. Since the intended (mass of metal/mass of catalyst) ratio was 15% as iron metal, the solution was added over a period of 2 h and the rate of addition of the liquid was substantially equal to the rate of evaporation of the water.

The catalyst was then heated at 180° C. for 4 h in the reactor so as to carry out the denitrification.

Despite the high temperature, the MBS particles retained their morphology perfectly.

At the end of the operation, the actual iron content of the catalyst was 13%.

### Example 2

### Preparation of Metal Catalyst/Polymer Composition No. 2

The same catalyst was prepared, but without carrying out the denitrification. As soon as the air was vented, the MBS/Fe composition started to oxidize slowly, giving off fumes. At the end of the operation, a black powder, consisting of 32% iron oxide and 68% carbon, was recovered.

### Example 3

### Preparation of Metal Catalyst/Polymer Composition No. 3

A catalyst was prepared from the same quantity of MBS, by adding 160 g of iron nitrate nonahydrate solution, i.e. 16 g of iron.

The preparation of the catalyst and the impregnation were carried out in the same way as Example 1, except that the addition was carried out over a time of about 6.5 h. The denitrification was carried out for 4 h. The actual iron content of the catalyst at the end of the operation was 23%.

### Example 4

### Preparation of Metal Catalyst/Polymer Composition No. 4

This catalyst was prepared from an aqueous cobalt acetate solution.

30 g of MBS were introduced into a jacketed 3-liter reactor heated to 100° C., through which a stream of nitrogen passed from the bottom up. The MBS particles were thus in a prefluidization state. Next, 100 ml of a cobalt acetate tetrahydrate solution containing 5.3 g of cobalt was then continuously injected by means of a pump. Since the intended (mass of metal/mass of catalyst) ratio was 15% as metal, the solution was added over a period of 2 h and the rate of addition of the liquid was substantially equal to the rate of evaporation of the water.

The actual cobalt content of the catalyst at the end of the operation was 12%.

### Example 5

### Preparation of Carbon Nanotubes and/or Fibrils

A catalyst test was performed by introducing, at a temperature between 600 and 700° C., a mass of about 2.5 g of catalyst into a reactor having a diameter of 5 cm and an effective height of 1 m, fitted with a disengagement zone intended to prevent fine particles from being entrained downstream. The gas was hydrogen/ethylene (with a 25%/75% vol/vol composition) with a total flow rate of between 100 and 300 Nl/h.

The catalyst was introduced in 5 stages, 0.5 grams at a time, so as to avoid an excessively high release of gas. The waiting time between each introduction was 10 minutes.

It was found that, at each introduction, a methane peak appeared in gas chromatography that was slightly higher than in the steady state.

The gas flow rate was sufficient for the solid to be well above the limiting fluidization velocity, while still remaining below the particle fly-off velocity.

After a certain reaction time, heating was stopped and the resulting quantity of product formed was evaluated. In parallel, the quality of the carbon nanotubes and fibrils was estimated by transmission microscopy.

The operating conditions and results of the 7 trials are given in Table 1 below:

TABLE 1

| | | Productivity | Ash | Properties of the |
|---|---|---|---|---|
| | | (g of C/g of | content | carbon nanotubes |
| No. | TRIAL | metal) | (wt %) | and/or fibrils |
| 1 | Catalyst 1: | 84 | 1.7 | Hollow fibers: |
| | 13% iron; | | | D from 25 to 200 nm. |
| | Q = 160 Nl/h | | | L from 1 to a few |
| | T = 600° C.; | | | microns. |
| | Duration = | | | A few nanotubes. |
| | 120 mins | | | |
| 2 | Catalyst 1: | 35 | 4 | Hollow fibers: |
| | 13% iron; | | | D from 25 to 200 nm. |
| | Q = 160 Nl/h | | | L from 1 to a few |
| | T = 700° C.; | | | microns. |
| | Duration = | | | A few nanotubes. |
| | 120 mins | | | |
| 3 | Catalyst 1: | 55 | 2.5 | Hollow fibers: |
| | 13% iron; | | | D from 25 to 200 nm. |
| | Q = 160 Nl/h | | | L from 1 to a few |
| | T = 650° C.; | | | microns. |
| | Duration = | | | A few nanotubes. |
| | 60 mins | | | |
| 4 | Catalyst 1: | 60 | 2.3 | Hollow fibers: |
| | 13% iron; | | | D from 25 to 200 nm. |
| | Q = 300 Nl/h | | | L from 1 to a few |
| | T = 650° C.; | | | microns. |
| | Duration = | | | A few nanotubes. |
| | 40 mins | | | |
| 5 | Catalyst 2: | 100 | 1.4 | Hollow fibers: |
| | 23% iron; | | | D from 25 to 200 nm. |
| | Q = 160 Nl/h | | | L from 1 to a few |
| | T = 600° C.; | | | microns. |
| | Duration = | | | A few nanotubes. |
| | 120 mins | | | |
| 6 | Catalyst 3: | 58 | 2.4 | Fibers from 150 to |
| | 23% iron; | | | 200 nm in diameter |
| | Q = 160 Nl/h | | | and nanotubes from 15 |
| | T = 650° C.; | | | to 20 nm in diameter. |
| | Duration = | | | |
| | 60 mins | | | |
| 7 | Catalyst 4: | 15 | 8 | Fibers 200 nm in |
| | 12% cobalt; | | | diameter and |
| | Q = 160 Nl/h | | | nanotubes from 15 to |
| | T = 600° C.; | | | 20 nm in diameter. |
| | Duration = | | | |
| | 60 mins | | | |

(L = length; D—diameter)

The fibers obtained in Trials 1 to 4 were well ordered and had either well-organized graphitic planes parallel to the axis, or planes inclined to the axis at an angle of about 30° (fishbone).

The productivity is expressed in grams of carbon produced per gram of metal introduced.

The conditions of Trials 1 and 5 allowed the highest productivities and lowest ash contents to be obtained.

These productivities are quite astonishing and appreciably higher than those generally obtained in the prior art. These results demonstrate that the presence of the organic substrate has an effect on the productivity of carbon nanotubes and/or fibrils.

In addition, by having burnt off the substrate, it is possible to recover carbon nanotubes and/or fibrils containing no mineral support other than the catalyst metal.

1. A catalyst material for the preparation of single-walled or multiwalled carbon nanotubes and/or fibrils, comprising:
one or more multivalent transition metals chosen from those of Group VIB, chromium Cr, molybdenum Mo, tungsten W, or those of Group VIIIB, iron Fe, cobalt Co, nickel Ni, ruthenium Ru, rhodium Rh, palladium Pd, osmium Os, iridium Ir and platinum Pt, or mixtures thereof; and
a solid organic substrate chosen from polymers, copolymers and terpolymers that contain only carbon and hydrogen.

2. (canceled)

3. (canceled)

4. The material as claimed in claim 1, wherein the organic substrate is chosen from polymers, copolymers and terpolymers, wherein at least some repeating units thereof comprise butadiene and/or styrene.

5. The material as claimed in claim 1, wherein the organic substrate is chosen from core-shell methacrylate/butadiene/styrene polymers of the or crosslinked polystyrene/divinylbenzene polymers.

6. The material as claimed in claim 1, wherein the transition metal is chosen from iron Fe, cobalt Co and nickel Ni, or a mixture thereof.

7. The material as claimed in claim 1, wherein the amount of transition metal(s) represents up to 50% by weight of the final catalyst material.

8. The material as claimed in claim 1, wherein the organic substrate is a porous support impregnated with the metal.

9. (canceled)

10. (canceled)

11. A method for preparing the catalyst material of claim 1, comprising bringing the organic substrate into contact with a solution containing at least one of said transition metals in salt form.

12. A method as claimed in claim 11, wherein the solution is an aqueous metal nitrate solution.

13. The A method as claimed in claim 11, wherein the contacting takes place at a temperature between room temperature and the boiling point of the solution and wherein the amount of liquid, at any moment in contact with the substrate is just sufficient to form a film on the surface of the particles.

14. The method as claimed in claim 12, wherein denitrification of the catalyst takes place in an inert atmosphere.

15. A method for preparing single-walled or multiwalled carbon nanotubes and/or fibrils, comprising the steps of:
a) supplying a catalyst material according to claim 1;
b) growing carbon nanotubes and/or fibrils by thermal decomposition of the organic substrate, by heating the catalyst material to a temperature between 300 and 1200° C. in the presence of a hydrocarbon gas composition which optionally includes a reducing gas; and
c) cooling and recovery of the carbon nanotubes and/or fibrils formed.

16. The method as claimed in claim 15, characterized in that the hydrocarbon gas is ethylene mixed with hydrogen as a reducing gas, the gas composition containing at least 20% hydrogen by volume.

17. The method as claimed in claim 16, wherein step b) is carried out on a fluidized bed in the presence of the hydrocarbon gas and optionally reducing gas.

18. (canceled)

19. The method as claimed in claim 15, wherein the metal of the catalyst material is reduced in situ during step b) of preparing the carbon nanotubes.

20. A polymeric composition comprising at least one polymer mixed with carbon nanotubes and/or fibrils obtained according to the method of claim 15 resulting in improved mechanical and/or thermal and/or electrical conductivity properties in polymeric compositions.

21. A material according to claim 7, wherein the transition metal represents 1-30% by weight of the final catalyst material.

22. A material according to claim 7, wherein the transition metal represents 1-15% by weight of the final catalyst material.

23. A method according to claim 11, wherein said contact is conducted under a stream of dry gas.

24. A method according to claim 12, wherein the solution is an aqueous iron nitrate solution.
